(19) United States
(12) Patent Application Publication
(10) Pub. No.: US 2008/0267218 A1
(43) Pub. Date: Oct. 30, 2008

(54) Media proxy for providing compressed files to mobile devices

(75) Inventors: Mikko Linnamaki, Stuttgart (DE); Tero Katajainen, Helsinki (FI)

Correspondence Address: CARR & FERRELL LLP, 2200 GENG ROAD, PALO ALTO, CA, 94303, US

(73) Assignee: Liquid Air Lab GmbH

(21) Appl. No.: 11/796,241

(22) Filed: Apr. 27, 2007

(51) Int. Cl. H04J 3/18

(52) U.S. Cl. 370/477

(57) ABSTRACT

Architecture for providing a compressed replacement media file to a mobile device is provided. The method comprises receiving a first media file of a first format. The first media file is then compressed to generate a second media file of a second format. A request may be received from a mobile device for the first media file and the second media file is transferred to the mobile device via the Internet. Content may be added to the first media file such that the second media file comprises both the added content and the first media file. An indication that the second media file has been played on the f media device may be received.

### BACKGROUND

1. Field of the Present Invention

The present invention relates generally to data transfer to mobile devices and more specifically to a media proxy for providing compressed files to mobile devices.

2. Description of the Related Art

Currently, people are able to download media content via the Internet. This media content includes videos, podcasts, and streaming radio broadcasts. As used herein, podcasts are, for example, audio or video files that are associated with a universal resource locator (URL), and are not limited to files that may be played on an Apple iPod®. Using a web browser, a person can access the content by navigating to the URL. The media content may also be associated with a feed that indicates whether the media content has been updated. Examples of feeds include RSS feeds or ATOM feeds. The files containing the audio and/or video media content, however, may be very large and/or require a large amount of bandwidth to download.

Mobile devices capable of receiving and transmitting data using transmission control protocol (TCP) and Internet protocol (IP) technology are frequently used by people to access the Internet. These mobile devices include mobile telephones, personal digital assistants (PDAs), and the like. The data communications providers supporting these capabilities, however, may offer limited bandwidth and other resources. A mobile device user may also pay for data communications by the amount of data transferred. For example, a user may pay a fixed rate per megabyte of data downloaded. As such, downloading media content and other large files to a mobile device may be time-consuming and/or expensive. Further, the mobile device itself has a limited amount of memory, and thus limits the amount of media that the user can store in the mobile device.

Media content may be compressed to decrease the size of the media file to be downloaded. Current compression formats include MPEG layer three (MP3), Ogg Vorbis (OGG), Advanced Audio Coding (AAC), AAC+, Windows Media Audio (WMA) for example MP4, Mov, WMV, Flash video formats, ZIP, and the like. Media files are typically provided in a compressed format by the publisher of the media file on the Internet. The compressed file can be downloaded at the URL at which the media is published. The user may be given an option to download media files having various compression formats. For example, a user may select to download a media file as an MP3 file or as an AAC file. In many instances, however, content is not compressed prior to downloading because personal computers are able to download larger files over a greater bandwidth. In instances where the media is compressed, the data file may still be too large to be easily downloaded to a mobile device. For example, a podcast may comprise multiple episodes, even twenty or thirty or more. Episodes may be of any length; between ten and fifty megabytes in size is not uncommon.

As such, there is a need to deliver a compressed, or further compressed, media file to a mobile device.

### SUMMARY OF THE INVENTION

The present invention provides methods for providing media files to a mobile device. The present invention provides for the addition of content to a media file and compression of the media file, so that the file may be played without using a large amount of bandwidth or memory.

In one embodiment, a method for providing media files to a mobile device comprises: receiving a first media file of a first format; compressing the first media file to generate a second media file of a second format; receiving a request from a mobile device for the first media file; and transferring the second media file to the mobile device via the Internet.

In another embodiment; a method for providing media files to a mobile device comprises: receiving a first media file and a second media file; receiving a request from a mobile device for the first media file; generating a third media file comprising the first media file and the second media file; and transferring the third media file to the mobile device via the Internet.

The above-described embodiments are exemplary. One skilled in the art will recognize and appreciate various applications of the disclosed invention beyond those presently described here. This disclosure is not meant to be limiting beyond those limitations as expressly provided in the claims.

### BRIEF DESCRIPTION OF THE DRAWINGS

FIG. 1 depicts an exemplary environment in which various embodiments of the present invention may be practiced;

FIG. 2 is a block diagram of an exemplary mobile device according to one embodiment of the present invention;

FIG. 3 is a flowchart of an exemplary method for providing a media file to a mobile device according to one embodiment of the present invention;

FIG. 4 is a flowchart of an exemplary method for providing a media file having additional content to the mobile device according to one embodiment of the present invention; and

FIG. 5 is a flowchart of an exemplary method for requesting and receiving the media file at the mobile device according to one embodiment of the present invention.

### DETAILED DESCRIPTION

A system and method for providing a media file to a mobile device are provided. The media file may comprise audio and/or video data. The media file may be retrieved from a URL on the Internet and compressed by a proxy server. The proxy server may generate a menu or other graphical user interface indicating media files that have been retrieved. In response to a request for a specific media file, the proxy server transmits the compressed replacement media file to the mobile device. Transmitting a compressed replacement media file allows the mobile device to download the media file in less time and reduces the amount of bandwidth used by the mobile device. Further, by retrieving only new content based on a feed, a mobile device user is able to download the latest media files from the Internet. In further embodiments, the proxy server may insert additional content, such as advertisements, into the compressed replacement media file prior to the media file being downloaded to a mobile device. In addition, the mobile device may retrieve additional content from another source based on a characteristic of the original file for later use.

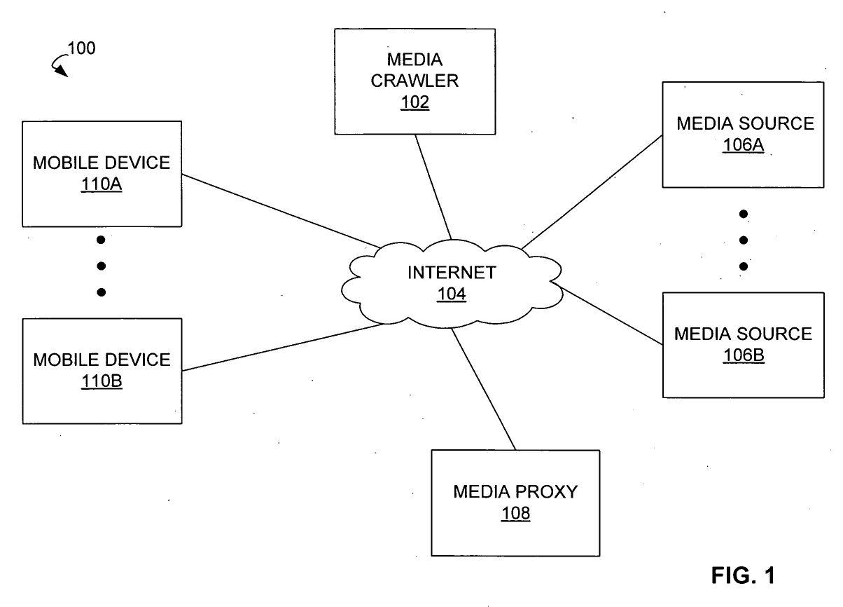

FIG. 1 depicts an exemplary environment 100 in which various embodiments of the present invention may be practiced. The environment 100 comprises a media crawler 102, one or more media sources 106A and 106B, a media proxy 108, and one or more mobile devices 110A and 110B capable of communicating with the media crawler 102, the media sources 106A and 106B, and/or the media proxy 108 via the Internet 104.

The media crawler 102 is configured to crawl URLs associated with the Internet 104 for media sources 106A and 106B. The media crawler 102 may comprise a list of known media URLs. In some embodiments, the media crawler 102 comprises a scheduler configured to initiate a crawl according to a specified schedule. For example, the media crawler 102 may be scheduled to initiate an Internet crawl daily at two a.m.

The media sources 106A through 106B may comprise media files, such as podcasts, associated with a URL. The media files may be stored in a file format such as MP3, OGG, AAC, WMA, for example, MP4, Mov, WMV, Flash, ZIP, or the like, and may be of any size.

The media proxy 108 may be configured to receive the media files via the media crawler 102. The media proxy 108 processes and/or compresses the media files retrieved from the media sources 106A and 106B, or, if the media files are already compressed, further compresses them. The media proxy 108 may compress the file into a format such as MP3, AAC, AAC+, OGG, WMA, MP4, Mov, WMV, or Flash. In some embodiments, the media proxy 108 further compresses a file compressed at the media sources 106A and 106B. In some embodiments, the media proxy 108 may compress a media file of ten to fifty megabytes to a size of less than ten megabytes or even one megabyte.

In some embodiments, the media proxy 108 may add content to the media files retrieved from the media sources 106A and 106B. The content may comprise an advertisement, a promotion, a preview of other content, or the like. The media proxy 108 may place the additional content at any point within the media file including the beginning and the end of the media file. The media proxy 108 compresses both the additional content and the media file into a single file that that is available for download to the mobile device 110A. In other embodiments, the additional content and the media file may be available for download as separate files. In these embodiments, downloading the media file may trigger a download of the additional content.

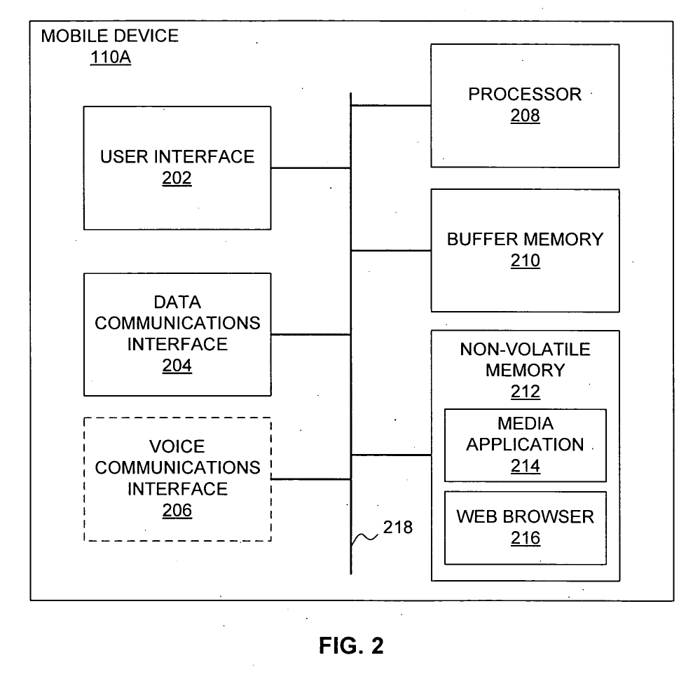

The mobile devices 110A and 110B comprise a computing device configured to communicate over the Internet. Examples of the mobile devices 110A and 110B include mobile telephones, personal digital assistants, personal media players, and the like. An exemplary mobile device is further described in connection with FIG. 2.

In operation, the media crawler 102 identifies media sources 106A and 106B on the Internet 104. The media proxy 108 retrieves the media files from the media sources 106A and 106B. The media proxy 108 may compress the media files and/or add content to the compressed file. The compressed file is suitable for download to the mobile devices 110A and 110B. The media proxy may additionally generate a menu or other display indicating the media files available for download to the mobile devices 110A and 110B. The mobile devices 110A and 110B receive the menu and display the menu to the user. The mobile device 110A receives a media file selection from the user and transmits a parameter indicating the selection to the media proxy 108. In response, the media proxy 108 transfers the compressed replacement media file to the mobile device 110A. The transfer may by executed by downloading the media file to the mobile device 110A or by streaming the media file to the mobile device 110A. In other embodiments, the exemplary environment 100 may include a mobile device 110B configured to communicate directly with the podcast proxy.

FIG. 2 is a block diagram of an exemplary mobile device 110A according to one embodiment of the present invention. The mobile device 110A comprises a user interface 102, a data communications interface 204, an optional voice communications interface 206, a processor 208, a buffer memory 210, and a non-volatile memory 212 connected by a bus 218.

The user interface 202 enables the user to interact with the mobile device 110A and may comprise a display, a speaker, a keypad, and/or a microphone. The data communications interface 204 is configured to transmit and receive data using third generation wireless (3G) technology, a wireless local area network (WLAN) such as a wireless fidelity (WiFi)-compatible network, or other wireless data communications network. The optional voice communications interface 206 is configured to communicate over a cellular or other voice communications network for voice calling. The processor 208 is configured to execute instructions stored in the buffer memory 210 and the non-volatile memory 212. The buffer memory 210 comprises a re-writeable memory such as random access memory (RAM) or Flash memory. The non-volatile memory 212 may comprise read-only memory (ROM) and/or Flash memory.

A media application 214 is stored in the non-volatile memory 212. The media application 214, as discussed herein, is a program executable by the processor 208 to receive and play media content on the mobile device 112. In some embodiments, the media application 214 is updatable by the media crawler 102 and/or the media proxy 108. The media application 214 may direct the processor 208 to store streaming audio and/or video data in the buffer memory 210. Audio and/or video downloads, such as podcasts, advertisements, and/or music on-demand, may be stored in the non-volatile memory 212.

The mobile device 110A may also comprise a web browser 216 stored in the non-volatile memory 212. The web browser 216 is configured to access content published on the Internet 104 by navigating to a URL and displaying the posted content. The web browser 216 may be used by the media application 214 to access the Internet 104. The media application 214 may further transmit data to and/or receive data from the media proxy by navigating to a URL associated with the media proxy 108. In some embodiments, the media application 214 may be combined with the web browser 216.

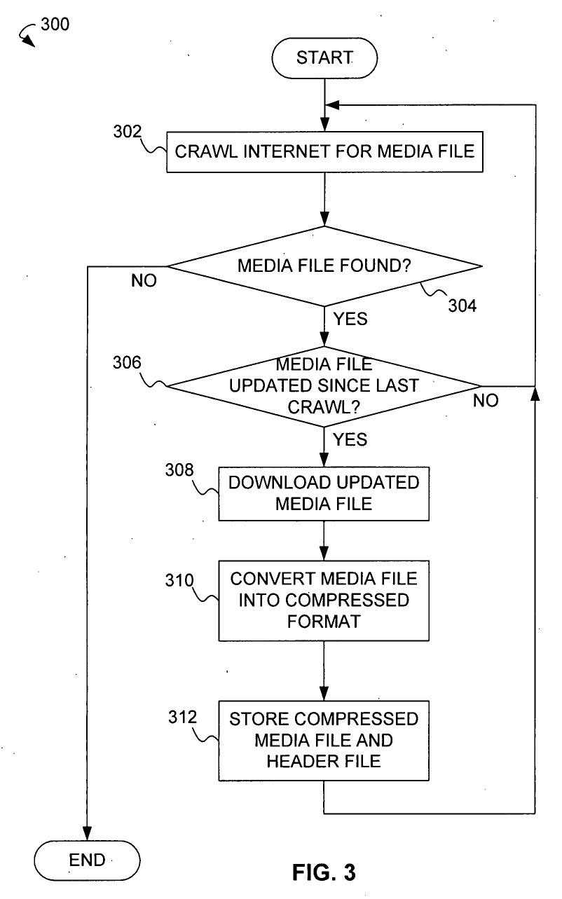

FIG. 3 is a flowchart of an exemplary method 300 for retrieving a media file using a media crawler according to one embodiment of the present invention. The method 300 provides for finding, verifying, retrieving, compressing and storing the media files. The method 300 may be performed, for example, by the media crawler 102 and/or the media proxy 108. In some embodiments, the media crawler 102 and the media proxy 108 may be embodied in a single entity.

In step 302, a media crawler crawls the Internet for media files to download. As above, the media files may comprise audio and/or video data. The media crawler may base its search on a database comprising URLs associated with media files. If a media file is found at the URL in step 304, a determination is made as to whether the media file has been updated since the last crawl in step 306. This determination may be based on a feed such as an RSS feed or an ATOM feed. For example, a media file such as a podcast is typically associated with an RSS file that includes an indication of when the podcast was last updated. The media crawler may read the RSS file to determine whether the podcast has been updated since the previous crawl. For example, the media crawler may compare a most recent update time stored in the RSS file to a time of the last crawl. If the media file has not been updated since the previous crawl, the media crawler continues crawling the Internet for other media files. In embodiments where a media file is posted without an associated feed, the media crawler may compare a time at which the media file was posted to the time of the last crawl.

If the media file has been updated since a previous crawl, the updated media file is downloaded in step 308. Typically, the downloaded media file comprises audio and/or video data. The downloaded media file may be associated with a header file that may also be downloaded. The header file may contain information such as title, author, publisher, time of last update, URL, or the like. For example, the media file may comprise a podcast or an episode associated with a podcast. If the media file comprises a podcast, only the episodes added since the last crawl may be downloaded. The media file and/or the header file may be downloaded by the media crawler to a specified location.

In step 310, the media file is converted into a compressed format. The media file may be compressed into a format such as MP3, OGG, AAC, AAC+, WMA, MP4, Mov, WMV, Flash, ZIP, or the like. In some embodiments, the media file may be converted from one format to another, for example, MP3 to AAC. In further embodiments, the media file may be converted from, for example, an MP3 file to a further compressed MP3 file. The resulting format should be one that is likely to be playable by a requesting mobile device.

In step 312, the compressed replacement media file and the header file are stored. The process 300 then continues by returning to step 302. The steps described may be performed by separate modules or a single module configured to crawl and compress the media files. For example, the media crawler 102 of FIG. 1 and the media proxy 108 may crawl the Internet and store the media, respectively. The media proxy 108 may perform the compression after the media file has been requested by the mobile device 110A.

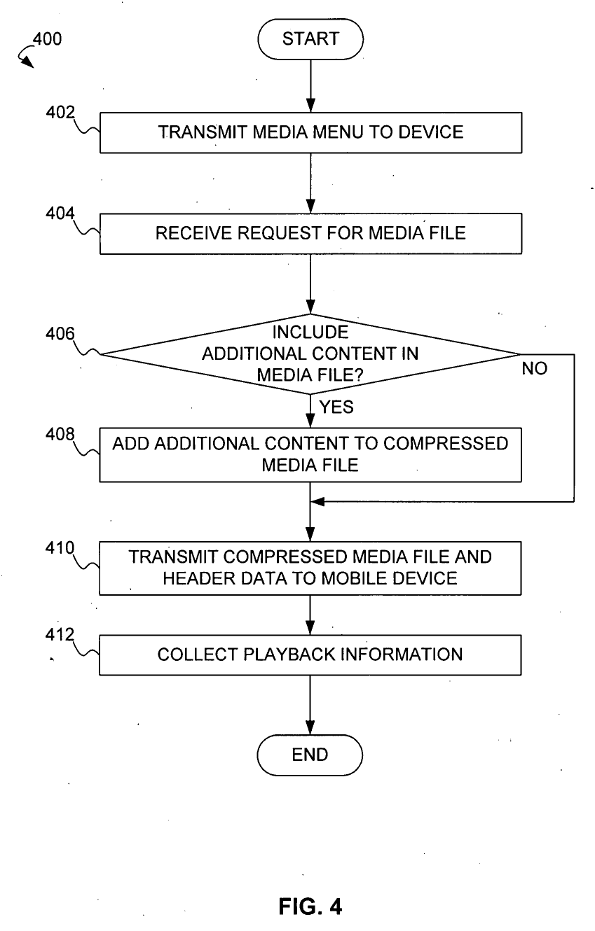

FIG. 4 is a flowchart of an exemplary method 400 for providing a media file having additional content to the mobile device 110 according to one embodiment of the present invention. The method 400 may be performed, for example, by the media proxy 108 of FIG. 1.

In step 402, a media menu is transmitted to a mobile device. The media menu may be transmitted in response to a selection received from a user of the mobile device. The media menu may comprise a textual listing of available media files, a graphical representation of the media files, or other graphical user interface (GUI). In some embodiments, the media menu may comprise an audio or video listing of the available media files. The user of the mobile device may access the media menu by browsing to a website. In some embodiments, the GUI may comprise the web browser 216. In some embodiments, the user may be able to request either a compressed or an uncompressed media file from a content source.

In step 404, a request for the media file is received from the mobile device. The request may be based on a selection of the media file by the user of the mobile device. The request for the media file may indicate a media file, for example, a podcast, or a portion of the media file, for example, an episode of the podcast. The request for the media file may also include an identifier to indicate, for example, which mobile device is requesting the media file.

In step 406, a determination is made as to whether to include additional content in the media file. The determination may further include selecting the additional content to be included in the media file. The additional content may, alternatively, not be included in the media file and may be selected to be downloaded as a separate file. The additional content may comprise an advertisement, an offer, a preview of other available content, content related to the selected media file, or other content.

The determination to include the additional content may be based on the identifier of the mobile device that requested the media file. The additional content may be selected based on information known about the user of the identified mobile device. For example, if the mobile device comprises a mobile telephone, the personal information may include a billing address, frequently called businesses, music playlists, listened content objects, user behavior, used software applications, social data, and demographic information collected by the mobile device software or a service provider. If the mobile device comprises an application for playing music or other media, preference information may be used. Information about the user of the mobile device may be retrieved from various sources, for example, Internet cookies, logs, register data, playlists, behavior data stored on the mobile device 110A. In some embodiments, the additional content may be selected based on the request for the media file received from the user. For example, if a podcast of an interview of Madonna is requested, an advertisement for Madonna's clothing, line may be selected.

If additional content is selected to be included in the media file, the additional content may be added to the compressed replacement media file in step 408. In some embodiments, the additional content is added to a compressed file and the combined file is transmitted as a single file to the mobile device. In other embodiments, the additional content may be added to a downloaded media file that has not yet been compressed. In some embodiments, the file may be recompressed after the additional content is added. In yet other embodiments, the additional content may not be added to the compressed media replacement file. The additional content may be stored in a separate file stored using a format such as MP3, OGG, AAC, AAC+, WMA, MP4, Mov, WMV, Flash, ZIP, or the like. The additional content may be added to the media file such that the additional content is played to the mobile device user at the beginning of the media file, at a midpoint in the media file, or at the end of the media file. In other embodiments, the additional content may be played at a later time.

In step 410, the compressed replacement media file and header data is transmitted to the mobile device. The compressed replacement media file, based in the determination made in step 406, may include the additional content. Alternatively, the additional content may be downloaded as a separate file. The header data may include at least a portion of the data contained in the header file. The compressed replacement media file, including additional content, may be downloaded or streamed to the mobile device.

In step 412, playback information may be collected based on whether the media file has been played on the mobile device. The playback information may include data indicating whether the mobile device has played the media file and/or the additional content included in the media file. In some embodiments, information identifying the downloaded and/or played media file may be tracked and later used to recommend other media files to the user of the mobile device.

In some embodiments, the additional content may be played to the user of the mobile device after the media file has played. For example, if an advertisement for clothing designed by Madonna is downloaded (as a separate file) with a media file of an interview with Madonna, the advertisement may be stored on the mobile device for later playback. A determination may be made to play the advertisement at another time. In some embodiments, the media file may be played after an elapsed period of time, when the mobile device requests another media file, or the like. The determination may be based on media being played by the mobile device. For example, the advertisement for clothing designed by Madonna may be played to the user of the mobile device the next day if a podcast about fashion is requested by the user.

In some embodiments, the user may browse the Internet for media files. If the user selects a media file from a particular content source, a proxy may transmit a compressed replacement media file to the mobile device rather than allowing the mobile device to download the media file directly from the content source.

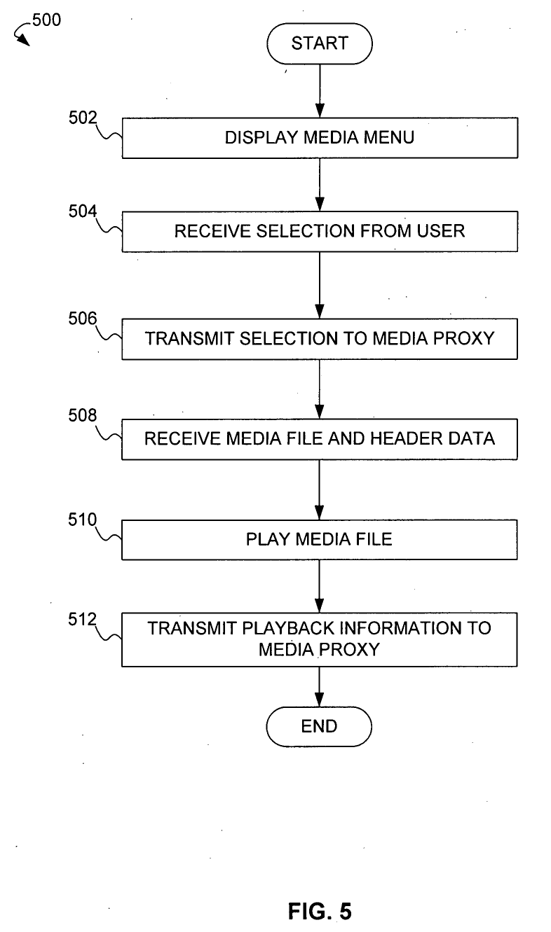

FIG. 5 is a flowchart of an exemplary method 500 for requesting and receiving the media file at a mobile device according to one embodiment of the present invention. The mobile device, such as mobile device 110A of FIG. 1, may comprise the media application 214 of FIG. 2. The media application 214 may access the Internet 104 via the web browser 216 to communicate with the media player 108.

In step 502, a media menu is displayed. The media menu may be received as described in connection with step 402 of FIG. 4. A selection is received from the user in step 504 based on the media menu. In step 506, the selection is transmitted to a media proxy. In alternative embodiments, the user may navigate to a content source and select the media file posted at the content source. In step 508, the compressed replacement media file and related header data are received. As described, the compressed replacement media file may comprise additional content such as an advertisement. In step 510, the mobile device plays the compressed replacement media file. In step 512, the playback information is transmitted back to the media proxy.

The present invention provides a system and method for providing a media file to a mobile device. As used herein, a “media file” may comprise audio and/or video data. The term “video” refers specifically to image data while the term “audio” refers to sound data. “Mobile device” as used herein, comprises a mobile telephone, personal digital assistant, personal music player such as a portable MP3 player, personal video gaming device, or the like.

In the foregoing specification, the present invention is described with reference to specific embodiments thereof, but those skilled in the art will recognize that the present invention is not limited thereto. Various features and aspects of the above-described present invention may be used individually or jointly. Further, the present invention can be utilized in any number of environments and applications beyond those described herein without departing from the broader spirit and scope of the specification. The specification and drawings are, accordingly, to be regarded as illustrative rather than restrictive. It will be recognized that the terms “comprising,” “including,” and “having,” as used herein, are specifically intended to be read as open-ended terms of art.

What is claimed is:

1. A method for providing a media file to a mobile device comprising:
receiving a first media file of a first format;
compressing the first media file to generate a second media file of a second format;
receiving a request from a mobile device for the first media file; and
transferring the second media file to the mobile device via the Internet.

2. The method of claim 1, further comprising determining whether to receive the first media file based on a feed associated with the first media file.

3. The method of claim 1, wherein transferring the second media file comprises streaming the second media file to the mobile device.

4. The method of claim 1, wherein transferring the second media file comprises uploading the second media file to the mobile device.

5. The method of claim 1, further comprising:
receiving a third media file; and
wherein the step of compressing the first media file further comprises compressing the first media file and the third media file to generate the second media file.

6. The method of claim 5, further comprising receiving an indication that the mobile device has played the second media file.

7. A computer readable medium having embodied thereon a program, the program being executable by a processor for performing a method for providing a media file to a mobile device, the method comprising:
receiving a first media file of a first format;
compressing the first media file to generate a second media file of a second format;
receiving a request from a mobile device for the first media file; and
transferring the second media file to the mobile device via the Internet.

8. The computer readable medium of claim 7, wherein the method further comprises determining whether to receive the first media file based on a feed associated with the first media file.

9. The computer readable medium of claim 7, wherein transferring the second media file comprises streaming the second media file to the mobile device.

10. The computer readable medium of claim 7, wherein transferring the second media file comprises uploading the second media file to the mobile device.

11. The computer readable medium of claim 7, the method further comprising:
receiving a third media file; and
wherein the step of compressing the first media further comprises compressing the first media file and the third media file to generate the second media file.

12. The computer readable medium of claim 11, the method further comprising receiving an indication that the mobile device has played the second media file.

13. A method for receiving a media file at a mobile device comprising:
requesting a media file using a web browser;
receiving the media file from a proxy server;
playing the media file; and
transmitting an indication that the media file has been played.

14. The method of claim 13, wherein transmitting the indication comprises transmitting the indication to the proxy server.

15. The method of claim 13, further comprising displaying a media menu indicating the media file.

16. The method of claim 13, further comprising:
receiving another media file based on a characteristic of the media file;
determining a time for playing the other media file;
playing the other media file at the determined time; and
transmitting an indication that the other media file has been played.

17. A method for providing a media file to a mobile device, comprising:
receiving a first media file and a second media file;
receiving a request from a mobile device for the first media file;
generating a third media file comprising the first media file and the second media file; and
transferring the third media file to the mobile device via the Internet.

18. The method of claim 17, further comprising compressing the third media file.

19. The method of claim 17, wherein transferring the third media file comprises streaming the third media file to the mobile device.

20. The method of claim 17, wherein transferring the third media file comprises uploading the third media file to the mobile device.

21. The method of claim 17, further comprising receiving an indication that the media file has been played on the mobile device.
